(19) United States
(12) Patent Application Publication
(10) Pub. No.: US 2002/0094169 A1
(43) Pub. Date: Jul. 18, 2002

(54) Method of laser welding

(76) Inventors: David Benator, Sachse, TX (US); John Killmeyer, Sachse, TX (US); Chris Loehrlein, Wylie, TX (US); Aaron Smith, Garland, TX (US); Uri Horowitz, Rishon Le-Zion (IL); Orit Potashnik, Tel Aviv (IL)

Correspondence Address: LASERCOMM, INC., INTELLECTUAL PROPERTY DEPT., 2600 TECHNOLOGY DRIVE SUITE 900, PLANO, TX, 75074, US

(21) Appl. No.: 10/043,321

(22) Filed: Jan. 14, 2002

Related U.S. Application Data
(60) Provisional application No. 60/261,266, filed on Jan. 16, 2001.

(51) Int. Cl. G02B 6/38; G02B 6/26; B23K 26/00

(52) U.S. Cl. 385/55; 219/121.64; 385/15

(57) ABSTRACT

A method of laser welding which controls the shifts inherent in laser welding by utilizing physical force and multiple welds. The parts are carefully aligned, and then a first laser weld utilizing symmetric simultaneous balanced beams is accomplished. Mechanical force is then applied. While maintaining the mechanical force additional laser welds are accomplished thus securing the element while maintaining proper alignment.

### CROSS REFERENCE TO RELATED APPLICATIONS

The present application claims priority to provisional U.S. patent application Ser. No. 60/261,266 filed Jan. 16, 2001 and incorporates by reference U.S. patent application Ser. No. 09/248,969 filed Feb. 12, 1999, U.S. patent application Ser. No. 09/515,959 filed Feb. 29, 2000 and U.S. patent application Ser. No. 09/613,858 filed Jul. 11, 2000.

### FIELD OF THE INVENTION

Laser welding of optically aligned parts and in particular a method of welding optical elements with alignment correction

### BACKGROUND OF THE INVENTION

In optical systems it is often required to perform a precise alignment and have the parts then fixed in place using either adhesive or a welding operation. Unfortunately, both methods present difficulties. In precise systems, such as in an optical interface element used in optical communication where the beam of light is focused onto the end of an optical fiber, alignment must be extremely precise. The core of the fiber, where the focus is to be maintained is in the range of 10 microns, and thus any minor deviation can cause significant loss. Adhesives can cure unevenly, thus changing the alignment of the parts, so that even if the parts are held in place during cure, when the complete unit is removed from its holder, the parts will adjust themselves to the setting of the adhesive and thus be misaligned. The units must occupy the fixturing for the period of the cure as well. Temperature changes, or aging of the adhesive may cause misalignment to occur. Laser welding is preferred for its strength and low cycle time, as well as its temperature and humidity stability; however, the strong temperature changes associated with laser welding can cause misalignment. A known method to prevent this misalignment is by accomplishing laser welding symmetrically with multiple beams, typically three or more beams, so as to balance out any motion caused by the laser welding process. Unfortunately, in the case of precise systems experience has shown that this balance is imperfect and some motion occurs during welding, thus causing misalignment.

U.S. Pat. No. 6,087,621 describes a method for “laser hammering” of a multichannel optoelectronic device module. The method requires forming at least one welded portion on a predetermined position of the optical fiber supporting member, thereby causing shrinkage deformation that adjusts the alignment in the desired direction. Compensating by utilizing a shrinkage effect is not always suitable, and requires a supporting member and an additional welded portion which adds cost and bulk.

Newport Corp. of Irvine Calif. in their press release of Jun. 24, 1996 describe their automated LaserHammer™ post-weld technology, which corrects for weld shift by calculating the proper location for an additional weld that will correct for the original weld shift. The method uses the laser welding distortion in order to create an opposing distortion bringing the parts back into alignment. This requires significant experience and programming power as it is difficult to predict the corrective distortion of the laser, thus resulting in a high number of iterations. It also does not provide a method to complete the stitching of the parts together.

There is therefore a need for a method of laser welding which can result in a finished part that is precisely aligned, and fully stitched together.

### SUMMARY OF THE INVENTION

Accordingly, it is a principal object of the present invention to overcome the problems associated with prior art laser welding methods, and provide a method which can result in precisely aligned finished part. In one embodiment, a method of laser welding an element which controls the shifts inherent in laser welding by utilizing physical force and multiple welds is described. Specifically, the parts are carefully aligned and then a first laser weld is accomplished. Preferably the part is released to allow for post weld shifting, and then physical force is applied to bring the element into proper alignment. While maintaining the physical force, a second laser weld is accomplished. In an exemplary embodiment, the second laser weld is accomplished in a location that has not been previously welded. Preferably additional welding is accomplished in still additional locations that have not been welded to secure the element in its position with a complete stitching.

In another embodiment the physical force is applied to bring the element past the point of alignment, such that the release of physical force after laser welding will allow the multiple sub-assemblies to move into the aligned condition. In a preferred embodiment, the second location is rotationally removed from the first location. Optionally, the rotational removal is a predetermined angle. Further optionally, the predetermined angle is 60 degrees.

In another embodiment, the method further comprises the step of laser welding the at least two sub-assemblies in a third location. Optionally, the third location is rotationally removed from the second location by a predetermined angle.

In another embodiment, the method involves aligning at least two subassemblies, laser welding the two subassemblies together, applying physical force, and then laser welding again in substantially the same location while maintaining the physical force.

In another embodiment the physical force is an angular force.

The invention also provides for an apparatus having multiple sub-assemblies produced in accordance with the method of aligning at least two sub-assemblies into an aligned condition, laser welding the at least two sub-assemblies in a first location, applying physical force to the at least two sub-assemblies and laser welding the at least two assemblies in a second location while maintaining the physical force.

The invention also provides for a method of laser welding multiple subassemblies of an optical element comprising the steps of aligning the sub-assemblies, laser welding the at least two sub-assemblies in a predetermined location, applying physical force, laser welding again in substantially the same location, releasing the physical force so that after allowing for post-weld shifting the sub-assemblies are welded into an aligned optical element.

Additional features and advantages of the invention will become apparent from the following drawings and description.

### BRIEF DESCRIPTION OF THE DRAWINGS

For a better understanding of the invention with regard to the embodiments thereof, reference is made to the accompanying drawings, in which like numerals designate corresponding elements or sections throughout, and in which:

FIG. 1 is a block diagram of an embodiment of an optical interface element requiring precise alignment;

FIG. 2 is an illustration of a ferrule inserted into the housing as shown in FIG. 1;

FIG. 3 is an illustration of a frontal view of the housing containing the ferrule and fiber;

FIG. 4 is a high level block diagram of a first embodiment of an optical system used to align the optical interface element shown in FIG. 1;

FIG. 5 is a high level block diagram of a second embodiment of an optical system used to align the optical interface element shown in FIG. 1, and FIG. 6 is a high level flow chart of the method followed to laser weld the optical interface element shown in FIG. 1.

### DETAILED DESCRIPTION OF THE INVENTION

The invention will be described in relation to an optical interface element, and in particular to a transverse spatial mode transformer of the type described in pending U.S. patent application Ser. No. 09/248,969 whose contents are incorporated herein by reference. This is not meant to be limiting in any way, and the invention is equally suitable for an optical interface element providing coupling between two optical fibers, an optical fiber and an optical element, or for any element wherein laser welding is utilized and precise positioning is required.

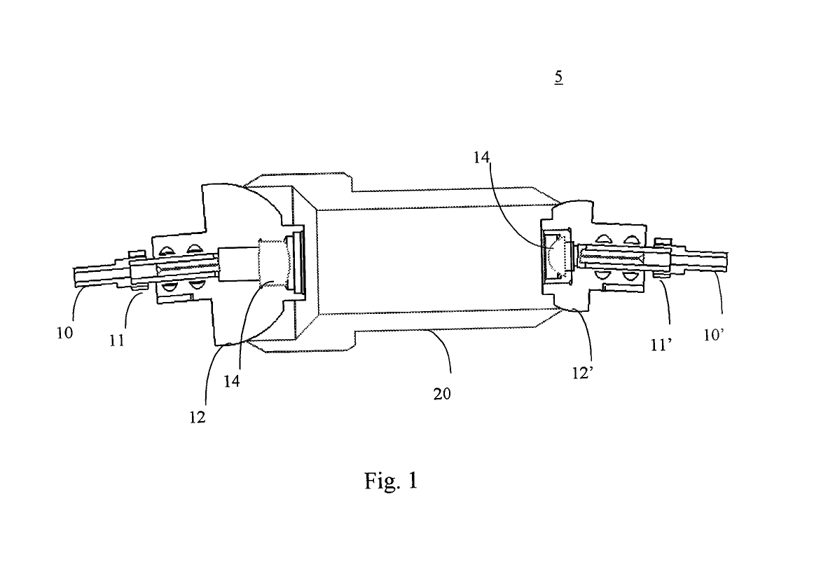

FIG. 1 shows an optical interface element 5, such as a mode transformer requiring precise alignment comprising optical fibers 10 and 10′, ferrule 11, housing 12, collimating lens 14 and pipe 20. Optical fiber 10 is encased in ferrule 11, and polished at the desired angle to prevent back reflection in a manner known to those skilled in the art. Ferrule 11 is inserted into housing 12, which contains collimating lens 14. Housing 12 and 12′ are placed at either end of pipe 20. Prior to securing ferrule 11, the collimated beam is observed to ensure proper placement of the ferrule, and then the ferrule is secured into place using a set screw, adhesive or laser welding in a method to be described herein.

Optical elements, such as phase elements (not shown) may be secured within pipe 20 so as to modify the optical beam in a manner known to those skilled in the art. An exemplary embodiment of such elements arranged to accomplish mode transformation is described in pending U.S. patent application Ser. No. 09/248,969 and Ser. No. 09/515,959 whose contents are incorporated herein by reference. In an exemplary embodiment housing 12, 12′ comprises a high precision optical collimator of the type described in pending U.S. patent application Ser. No. 09/613,858 whose contents are incorporated by reference. Pipe 20 exhibits different radii at each end of the pipe, so as to match the respective sizes of the housings 12 and 12′. The sizes of housings 12 and 12′ are determined by the required optics of the respective fibers 10 and 10′. In one embodiment fiber 10 is a standard single mode fiber, and fiber 10′ is a few mode fiber designed so as to perform dispersion compensation. Alignment of the assembly is accomplished by tilting housing 12 and 12′ respectively against pipe 20 until the light path is optimum.

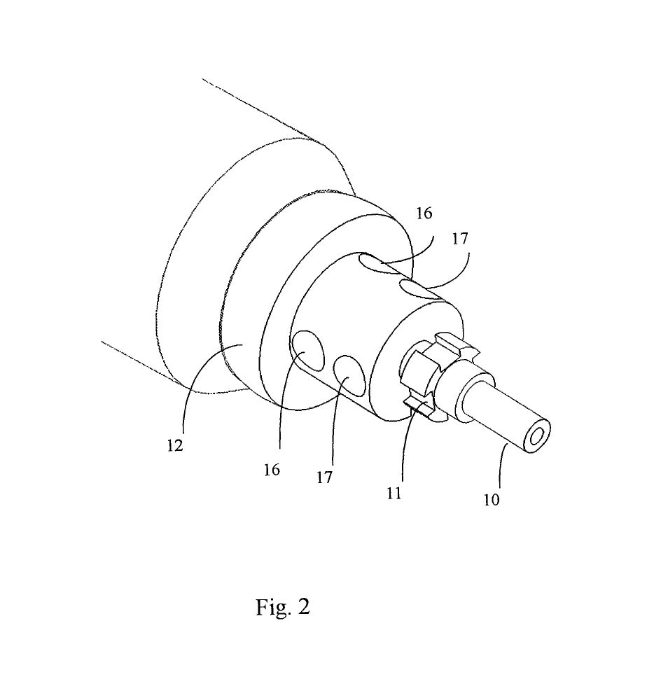

FIG. 2 illustrates a close up view of ferrule 11 inserted into housing 12 showing holes 16 and 17. Ferrule 11 is set to the proper location for collimation by methods known to those skilled in the art. In one embodiment comparison of the collimated beam to an expected reference pattern is utilized. Preferably, to avoid backlash, the ferrule is first inserted past the optimum point, and slowly withdrawn until collimation is achieved. Laser welding is accomplished through holes 16 with a simultaneous beam of a laser from multiple heads (not shown) arranged symmetrically around the unit. Once laser welding at a single set of points has been accomplished, optimum collimation is again confirmed. In the event that collimation is no longer optimum, a small pre-load force is applied in the desired direction. While maintaining the force, laser welding is again accomplished without changing position of the laser heads. It is important to note that only a small amount of force is required, as overcompensation can occur with a large force. The proper amount of required force is developed by experience so as to obtain the precise amount required for repositioning without overcompensating.

The laser heads are now repositioned so as to allow for laser welding at holes 17. In one embodiment a small lateral force is used to adjust ferrule 11 until the collimation beam is improved. Ferrule 11 is then laser welded at holes 17 thus securing ferrule 11.

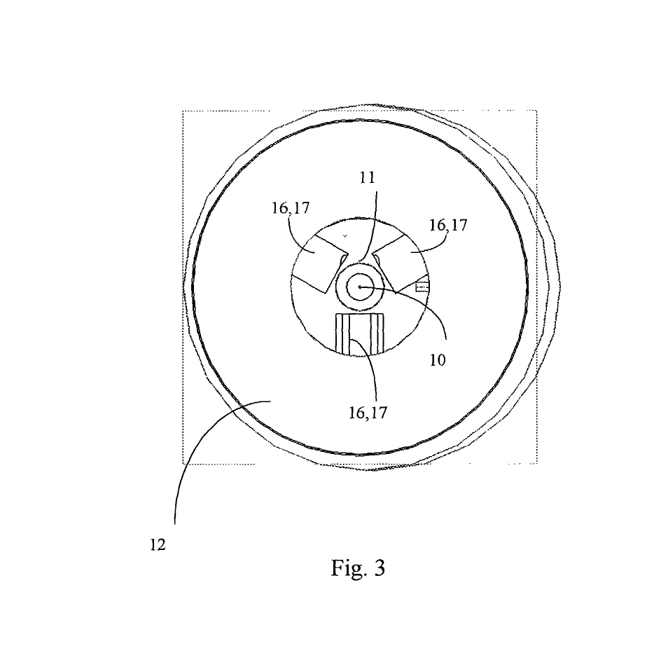

FIG. 3 illustrates a cut-away frontal view of housing 12 with ferrule 11 securing the end of fiber 10 inserted. Symmetric holes 16 and 17 are drilled through housing 12 to a depth just short of ferrule 11. In an exemplary embodiment ferrule 11 is metalized. In another embodiment ferrule 11 comprising a metal jacket with a zirconia insert. In an exemplary embodiment holes 16 and 17 are drilled through to a depth within 0.1 mm-0.2 mm of the inner wall of housing 12, leaving sufficient metal for laser welding.

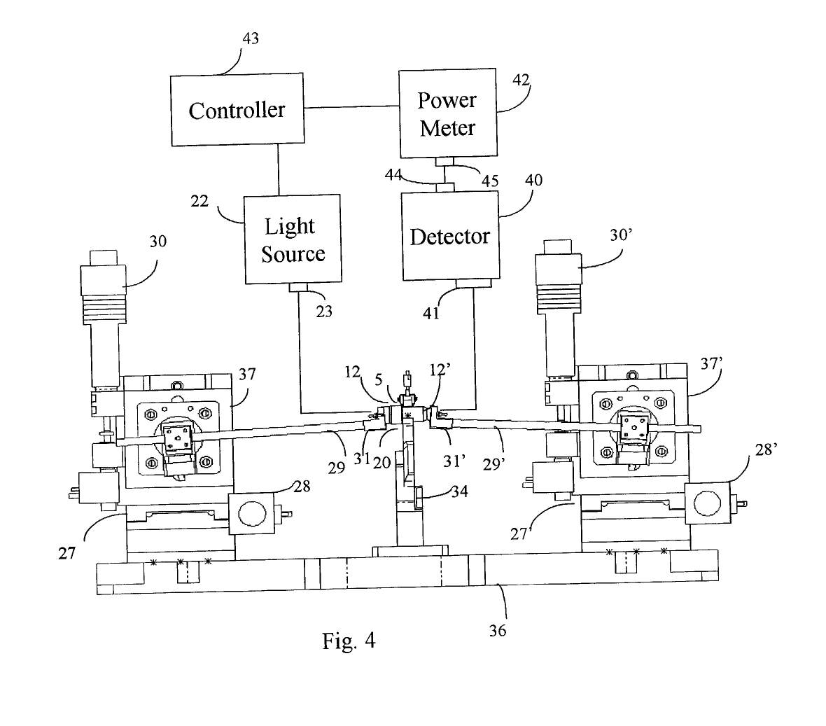

FIG. 4 illustrates a high level diagram of an embodiment of a first optical system designed to perform alignment comprising optical interface element 5, optical fibers 10 and 10′, housing 12 and 12′, pipe 20, holder 34, optical table 36, light source 22, arm 29 and 29′, jig 31 and 31′, mechanical stage 27, 27′, 37 and 37′, stepper motors 28, 28′, 30 and 30′, detector 40, power meter 42 and controller 43. Optical interface element 5, comprising pipe 20 and housing 12, 12′ is secured in location by holder 34 which is attached to optical table 36. Housing 12 and 12′ are placed at appropriate ends of pipe 20 of optical interface element 5, and held in location by jig 31, 31′. Jig 31 is connected by arm 29 to mechanical stages 27 and 37, which are in an exemplary embodiment arranged at right angles to each other to allow for controlled x,y motion. Similarly jig 31 ′ is connected by arm 29′ to mechanical stages 27′ and 37′, which are in an exemplary embodiment arranged at right angle to each other to allow for controlled x,y motion. Mechanical stage 27, 27′ is moved by stepper motor 28 and 28′ respectively in the x plane, and mechanical stage 37, 37′ is moved by stepper motor 30 and 30′ respectively in the y plane. Stages 27 and 27′ are secured to optical table 36 so as to ensure consistent optical alignment.

Stepper motors 28, 28′, 30 and 30′ are controlled by controller 43, with the connections not shown for clarity. Housing 12 has inserted thereto one end of fiber 10, and the second end of fiber 10 is connected to the optical output 23 of light source 22. Housing 12′ has inserted thereto one end of fiber 10′, and the second end of fiber 10′ is connected to the optical input 41 of detector 40. The electrical output 43 of detector 40 is connected to input 45 of power meter 42. Controller 43 is connected to power meter 42, light source 22, and stepper motors 28, 28′, 30 and 30′. The connections to stepper motors 28, 28′, 30 and 30′ have been omitted for clarity.

In operation, light source 22, which in one embodiment is a broad band light source operating with a center wavelength of 1550 nm, transmits through output port 23 an optical beam of a fixed power level, which is carried through optical fiber 10 which in one embodiment consists of a single mode optical fiber. Light carried through optical fiber 10 enters the interface element 5 through housing 12, which can be tilted against pipe 20 as shown in FIG. 1. Housing 12 is securely held by jig 31, and jig 31 is connected to arm 29. Movement of arm 29 tilts housing 12 against pipe 20 Light exits interface element 5 through second housing 12′, into second optical fiber 10′, which in one embodiment may consist of a few mode fiber designed to provide dispersion compensation in a high order mode, and enters detector 40 at optical input port 41. Detector 40 translates the intensity of the received light to a voltage level and its electrical output 44 is connected to input 45 of power meter 42. In another embodiment second optical fiber 10′ is a single mode fiber and is detected by a detector 40 which is connected to a power meter 42. In one embodiment the detector 40 is a GaAs detector, but any detector which is capable of detecting the power of the wavelengths of light generated by the light source 22 may be used. It is to be understood that many commercially available power meters contain an inherent detector 40 and thus a separate detector is not required. Housing 12′ is held securely against pipe 20 by jig 31′, with the jig being connected to arm 29′. Movement of arm 29′ positions unit 12′.

In the embodiment shown, arms 29, 29′ are moved by a respective pair of motors, or stepper motors, 28, 28′, 30 and 30′, which in one embodiment is part of a Melles Griot nanopositioning modular system, of Cambridge England, Product No. 17DRV005, through mechanical stages 27, 27′ and 37, 37′ respectively. In the embodiment shown, each pair of motors 28, 30 and 28′, 30′ includes one motor aligned along each axis which is orthogonal to the longitudinal axis of the respective arm 29. Other orientations of the motors 28, 30, 28′, 30′ are possible as known to one skilled in the art. The operation of each motor 28, 30, 28′, 30′ is controlled by a controller 43 which is connected to the motors 28, 30, 28′, 30′ (connections not shown) and the power meter 42. Controller 43 consists in one embodiment of a computer such as a personal computer, connected to stepper motor controller modules. In one embodiment, alignment is achieved by the pivoting of housing 12 and 12′ relative to fixed pipe 20. In another embodiment housing 12, 12′ are translated relative to fixed pipe 20. It is to be understood that the above description is not meant to be limiting in any way, and is meant to include any mechanical aid for rotating or translating the optical elements relative to each other or relative to the fixed pipe 20.

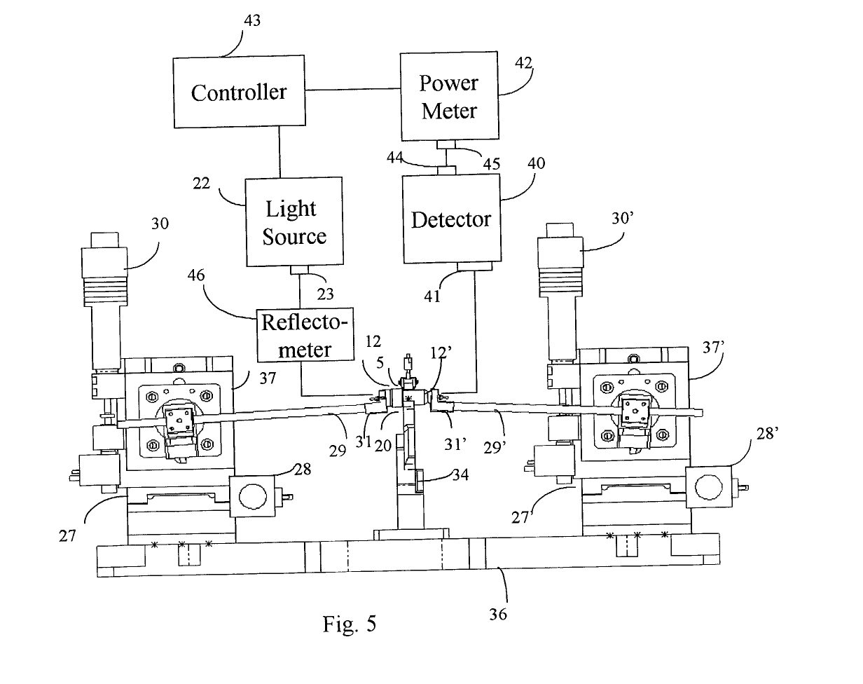

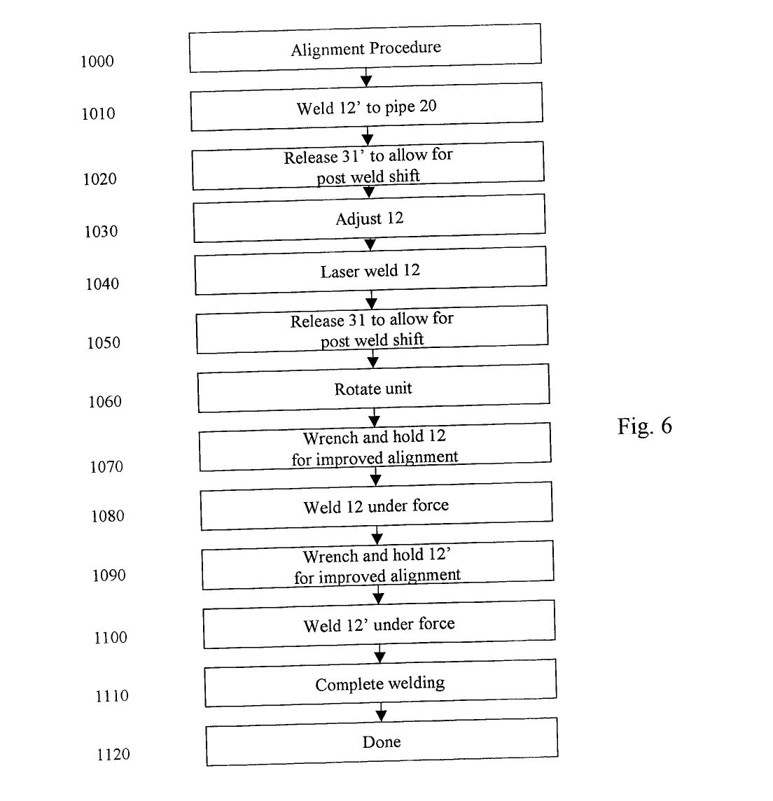

FIG. 5 illustrates a high level block diagram of an embodiment of a second optical system designed to perform alignment is depicted and is particularly useful when the optical interface element is a spatial mode transformer. The system is in all respects identical with the one described in connection with FIG. 4 with the exception that a precision reflectometer 46 such as the Ando AQ7410 High Resolution Reflectometer (Ando Corporation, Rockville Md. or www.andocorp.com) is connected between light source 22 and optical fiber 10, and optionally detector 40 and power meter 42 can be deleted. The reference utilized for the precision reflectometer 46 is a length of single mode fiber of appropriate length. The reflectometer 46 is in one embodiment utilized in combination with the power meter 42 or in another embodiment in place of the meter, and indicates by reflection the level of the different spatial modes being propagated in the few mode fiber 10′. Using the reflectometer, undesired modes can be minimized, as their time of travel through the fiber is different than that of the desired mode. Desired modes and undesired modes can thus be directly viewed by the reflectometer, and the power of the desired mode can be maximized. Other feedback mechanisms that may suit the needs of the specific optical elements may be utilized without exceeding the scope of the invention.

Laser welding is accomplished with a high power laser such as a YAG laser welder. In a preferred embodiment, the laser welding points are arranged symmetrically around the unit so as to minimize any shift caused by laser welding. Other laser welding configurations are useable without exceeding the teaching of this invention, including configurations having more or less than three heads, and an optical interface element comprising only a single adjustable part for alignment.

FIG. 6 is a high level flow chart of the method of laser welding. In step 1000 the optical interface element is aligned for optimum operation using a program contained in controller 43 or in a computer attached to controller 43. The program controls motors 28, 28′, 30 and 30′ so as to step through all possible combinations and to find the optimum alignment. Other algorithms that find the optimum alignment may also be utilized, as well as manual alignment techniques. An optimum alignment is found when the maximum reading from power meter 42 is achieved, or according to the specific application of the optical element. In the event the system of FIG. 5 is utilized in combination with reflectometer 46, a secondary target of the highest extinction ratio, i.e. ratio between the desired peak and the next highest peak is utilized as a consideration for small changes in the power reading.

In step 1010 housing 12′ is laser welded preferably with a single laser discharge from all the heads of the laser welding unit. The housing chosen for initial welding is the more sensitive of the two housings so as to allow the largest margin for initial correction. Typically this laser welding results in a misalignment of the unit, as indicated by an increased loss in power meter 42, or a revised graph in the output of reflectometer 42′. In one embodiment in step 1020 the holder 31′ is released thus allowing housing 12′ to complete the post weld shift to its final position. In another embodiment, no significant stress is added by holder 31′, and step 1020 is skipped.

Step 1030 runs the alignment program on housing 12, so as to realign the element based on the current welded position of housing 12′. In almost all cases it is possible to adjust 12′ so as to correct for the shift of housing 12 In the event that an acceptable optimum can not be found, the element is discarded or reworked. Once the optimum alignment has been obtained, in step 1040 housing 12 is welded with a single discharge from heads 50. Welding housing 12 typically shifts the alignment from the optimum, and wrenching the unit back into alignment is required. In one embodiment, in step 1050 holder 31 is released, allowing housing 12 to complete it post weld shift and arrive at its welded position. In another embodiment, no significant stress is added by holder 31, and step 1050 is skipped.

In step 1060 element 20 is rotated so that the next set of welds will not overlap the first, and thus the first set of weld will maintain its strength. The angle to be rotated depends on the laser welding configuration, and in one embodiment is midway between two laser welds. In an embodiment where three symmetrically spaced heads are utilized, each separated by 120 degrees, the unit is thus rotated by 60 degrees prior to welding. In another embodiment utilizing three symmetrically spaced heads, the unit is rotated 40 degrees prior to welding, with the key factor in determining the rotation angle being that the second weld set to be made be as close to the original set a possible without having a heating and distorting effect on the first weld set. While the unit is described as being rotated this is not meant to be limiting, and is meant to include other methods of adding additional welds including rotating the laser heads, or having additional heads which can be discharged alternately.

In step 1070 housing 12 is wrenched and held utilizing a manual wrench 60, such as the one shown in FIG. 6. In an alternative embodiment, holder 31 is reattached and an alignment program is run to compensate for any post weld shift. In still another embodiment holder 31 is not detached, and the alignment program is run to compensate for any post weld shift. It is to be understood by those skilled in the art that this alignment program need not be the same as the initial alignment program of step 1000, as the range of motion is significantly reduced. In one embodiment when an optimum point is found, housing 12 is held in place with the force maintained, and in step 1080 housing 12 is welded to pipe 20 with a single discharge from laser heads 50. In a second embodiment, housing 12 is overcompensated with additional corrective force determined by the number of existing welds and the magnitude of correction as will be further described below. In step 1080 housing 12 is welded to pipe 20 with a single discharge from laser heads 50. Housing 12 is thus secured to pipe 20 by two sets of welds, each of which is in at least three symmetrically placed locations. In one embodiment wrench 60 or holder 31 is now released so as to allow the post weld shift to complete. In another embodiment, the wrench 60 or holder 31 does not significantly stress the part and is thus not released. In the case of the second embodiment, the overcompensation is designed such that the stress of the initial weld and the stress of the second weld will achieve optimum alignment.

In step 1090 housing 12′ is wrenched and held utilizing either a manual wrench 60, or holder 31′ is reattached and an alignment program is run. In another embodiment holder 31 ′ is not detached, and the alignment program is run to compensate for any post weld shift. It is to be understood by those skilled in the art that this alignment program need not be the same as the initial alignment program of step 1000, as the range of motion is significantly reduced. In one embodiment when an optimum point is found, housing 12′ is held in place, and in step 1100 housing 12′ is welded to pipe 20 with a single discharge from laser heads 50′. In a second embodiment, housing 12′ is overcompensated with additional corrective force determined by the number of existing welds and the magnitude of correction as has been described above in relation to the second embodiment and step 1080. In step 1100 housing 12′ is welded to pipe 20 with a single discharge from laser heads 50. Housing 12′ is thus secured to pipe 20 by two sets of welds, each of which is in three symmetrically placed locations. Wrench 60 or holder 31′ is now released so as to allow the post weld shift to complete. In another embodiment, holder 31′ is left attached and any post weld shift occurs with the holder attached. In another embodiment steps 1060 through 1100 are repeated one additional time so as to secure the unit in three sets of welds while maintaining a corrective force.

In step 1110 the welding process is completed in a conventional manner, that is without any manual force being applied. In one embodiment the unit is rotated and welded on each side alternatively until no further welds can be made and the maximum number of welds is achieved so as to secure the housings 12, 12′ to the pipe 20 in the optimum location. In another embodiment the unit is rotated and welded in one additional location so as to stake the alignment in place. It is preferable that the initial two sets of welds not be disturbed, as this will disturb the alignment, and therefore preferably no welds should overlap them.

After completion of step 1110, the unit is fully welded, and the operation is completed in step 1120.

If the element has a single adjustable side, such as in the case of attaching a fiber to a mirror or a detector, the same process is followed of welding, allowing for post weld shift and wrenching and holding the part while an additional set of welds are accomplished.

The above description is not meant to be limiting in any way, and is meant to include situations wherein the mechanical structure such as pipe 20 allows for additional play, in which case over-wrenching may be required so that after the mechanical forces are released the elements return to the correct alignment.

Having described the invention with regard to certain specific embodiments thereof, it is to be understood that the description is not meant as a limitation, since further modifications many now suggest themselves to those skilled in the art, and it is intended to cover such modification as fall within the scope of the appended claims.

We claim:

1. A method of laser welding multiple sub-assemblies of an optical element, said method comprising the steps of:
providing at least two sub-assemblies;
aligning said at least two sub-assemblies into an aligned condition;
laser welding said at least two sub-assemblies in a first location;
applying physical force to said at least two sub-assemblies,
laser welding said at least two sub-assemblies in a second location; and
releasing said physical force; whereby said multiple sub-assemblies are laser welded into an aligned optical element in said aligned condition.

2. The method of claim 1 wherein said force is angular force.

3. The method of claim 1 wherein said second location is rotationally removed from said first location.

4. The method of claim 1 wherein said second location is rotationally removed from said first location by a predetermined angle.

5. The method of claim 4 wherein said predetermined angle is 60 degrees.

6. The method claim 1 further comprising the step of laser welding said at least two sub-assemblies in a third location.

7. The method of claim 6 wherein said third location is rotationally removed from said second location by a predetermined angle.

8. The method of claim 1 wherein said physical force is applied to move said at least two sub-assemblies past the point of alignment.

9. The method of claim 1 wherein said physical force is applied to realign said at least two sub-assemblies into said aligned condition.

10. An optical element having multiple sub-assemblies produced in accordance with a method comprising the steps of:
providing at least two sub-assemblies;
aligning said at least two sub-assemblies into an aligned condition;
laser welding said at least two sub-assemblies in a first location;
applying physical force to said at least two sub-assemblies;
laser welding said at least two sub-assemblies in a second location, and releasing said physical force; whereby said multiple sub-assemblies are laser welded into an aligned optical element in said aligned condition.

11. The optical element of claim 10 wherein said force is an angular force.

12. The optical element of claim 10 wherein said second location is rotationally removed from said first location.

13. The optical element of claim 10 wherein said second location is rotationally removed from said first location by a predetermined angle.

14. The optical element of claim 13 wherein said predetermined angle is 60 degrees.

15. The optical element claim 10 further comprising the step of laser welding said at least two sub-assemblies in a third location.

16. The optical element of claim 15 wherein said third location is rotationally removed from said second location by a predetermined angle.

17. The optical element of claim 10 wherein said physical force is applied to move said at least two sub-assemblies past the point of alignment.

18. The optical element of claim 10 wherein said physical force is applied to realign said at least two sub-assemblies into said aligned condition.

19. A method of laser welding multiple sub-assemblies of an optical element, said method comprising the steps of:
providing at least two sub-assemblies;
aligning said at least two sub-assemblies into an aligned condition;
laser welding said at least two sub-assemblies in a predetermined location;
applying physical force to said at least two sub-assemblies;
laser welding said at least two sub-assemblies in substantially said location; and
releasing said physical force, whereby said multiple sub-assemblies are laser welded into an aligned optical element in said aligned condition.

20. The optical element of claim 19 wherein said physical force is a linear force.
